(19) United States
(12) Patent Application Publication
(10) Pub. No.: US 2021/0216593 A1
(43) Pub. Date: Jul. 15, 2021

(54) INSIGHT GENERATION PLATFORM

(71) Applicant: Microsoft Technology Licensing, LLC, Redmond, WA (US)

(72) Inventors: Binyan Chen, Bellevue, WA (US); Anjaneya Malpani, Bellevue, WA (US); Dheepak Ramaswamy, Seattle, WA (US); Andrew Parker Leach, Seattle, WA (US); Venkata Anil Kumar Revuru, Sammamish, WA (US); Ananthatejas Raghavan, Redmond, WA (US); Andrew Christian Owen, Sammamish, WA (US); Kaiqi Zhang, Bellevue, WA (US); Brian Scott Ruble, Bellevue, WA (US); Benjamin Douglas Witt, Bellevue, WA (US); Chuyue Zhang, Seattle, WA (US)

(21) Appl. No.: 16/743,709

(22) Filed: Jan. 15, 2020

(51) Int. Cl. G06F 16/9032; G06F 16/9035; G06F 16/9038; G06F 16/901

(52) U.S. Cl. CPC G06F 16/90328; G06F 16/9017; G06F 16/9038; G06F 16/9035

(57) ABSTRACT

A system and method for configuring an application is described. A mapping definition defines a mapping between a first level attribute, a second level attribute, and a third level attribute of the application. The first level attribute indicates a goal of an operation of the application. The second level attribute indicates a factor that contributes to the goal. The third level attribute indicating a metric associated with the factor. The system accesses metrics that measure of operations of the application by a plurality of user accounts. A graphical user interface is generated for the first level attribute and displays the metric from the third level attribute that is mapped to the second level attribute for a set of user accounts from the plurality of user accounts based on the mapping definition. The system generates a configuration setting for the application of the set of user accounts based on the metric of the third level attribute.

### TECHNICAL FIELD

The subject matter disclosed herein generally relates to a special-purpose machine that computes enterprise applications performance metrics, including computerized variants of such special-purpose machines and improvements to such variants. Specifically, the present disclosure addresses systems and methods for computing metrics related to operations of an application and generating application configuration settings based on the computed metrics.

### BACKGROUND

Measuring a performance of an operation of an application within an enterprise can be difficult to determine given the millions of data point entries and the lack of context of computed metrics. Furthermore, the effectiveness and accuracy of human-driven analysis of large sets of data is increasingly low compared to machine-driven analysis. For example, if an organization needs a time sensitive analysis of a data set that has millions of entries across hundreds of variables, no human could perform such an analysis by hand or mentally. Furthermore, any such analysis may be out-of-date almost immediately, should an update be required.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 is a block diagram illustrating an insight platform engine in accordance with one example embodiment.

FIG. 3 is a block diagram illustrating an insight generator in accordance with one example embodiment.

FIG. 4 is a block diagram illustrating a mapping module in accordance with one example embodiment.

FIG. 5 is a block diagram illustrating a definition architecture in accordance with one example embodiment.

FIG. 6 is a block diagram illustrating a behavior module in accordance with one example embodiment.

FIG. 7 is a diagram illustrating an example of a mapping definition in accordance with one example embodiment.

FIG. 8 is a block diagram illustrating a recommendation engine in accordance with one example embodiment.

FIG. 9 is a block diagram illustrating a benchmark insight module in accordance with one example embodiment.

FIG. 10 is a flow diagram illustrating a method for computing a set of insight attributes in accordance with one example embodiment.

FIG. 11 is a flow diagram illustrating a method for generating a recommendation in accordance with one example embodiment.

FIG. 12 is a flow diagram illustrating a method for applying the recommended configuration setting in accordance with one example embodiment.

FIG. 13 is a flow diagram illustrating a method for applying the recommended configuration setting in accordance with another example embodiment.

FIG. 14 is a flow diagram illustrating a method for computing enterprise indices in accordance with one example embodiment.

FIG. 15 is a flow diagram illustrating a method for rendering a graphical user interface in accordance with one example embodiment.

FIG. 16 illustrates a routine in accordance with one example embodiment.

FIG. 17 illustrates an example of a graphical user interface in accordance with one example embodiment.

FIG. 18 illustrates an example of a graphical user interface in accordance with one example embodiment.

FIG. 19 is a diagrammatic representation of a machine in the form of a computer system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a method for computing a performance of an operation of an application in an enterprise environment. An enterprise represents organizations or groups of users associated with an organization. In particular, the system provides an algorithm that calculates the performance of operations of the application from user accounts within an enterprise relative to the performance of operations of the same application from user accounts from peer enterprises (or from peer groups from the same enterprise). Peer enterprise include other enterprises having a common industry or size of employees.

The system computes metrics based on an outcome (also referred to as a goal) selected by an administrator or user of the application. The outcome or goal indicates a desired performance of the operation of the application. For example, the desired performance includes an increased communication, interaction, or collaboration among users of the application.

The metrics may be measured based on data points that indicate usage of the application. The system generates a graphical user interface that identifies outlier user accounts within the enterprise (e.g., users or groups of users with relatively low interactions or one-on-one meetings with their managers). The system provides a recommendation that includes an application configuration setting for the outlier user accounts. In one example, the system implements a plan to increase or decrease metrics of the outlier user accounts by generating periodic notifications to the outlier user accounts. In another example, the system applies the configuration setting to the application of each outlier user account. The applied configuration setting modifies on the application operates for each outlier user account.

In another example embodiment, the system determines peer enterprises based on a profile of the enterprise (e.g., peer enterprises in a same industry as the enterprise). The system generates a graph that displays different aspects of the performance of the enterprise relative to its peer enterprises. The system computes the performance of the enterprise based on metrics corresponding to the enterprise. The system accesses data points from an enterprise application (e.g., an application that is operated/used by users of the enterprise). For example, devices associated with the enterprise communicate with a remote server hosting the enterprise application. In other examples, the devices associated with the enterprise include a local copy of the enterprise application and communicate user activities of a local copy to the remote server.

In one example embodiment, the data points include user activities associated with the enterprise application of the enterprise. Examples of data points include frequency, dates, times of users operating the enterprise application, types of documents being accessed or shared by users of the enterprise application, users calendar data from the enterprise application, communication data between users of the enterprise application, and enterprise organization data. Examples of enterprise applications include email applications, document editing applications, document sharing applications, and other types of applications used by enterprises.

In another example embodiment, a system and method for configuring an application is described. A mapping definition defines a mapping between a first level attribute, a second level attribute, and a third level attribute of the application. The first level attribute indicates a goal of an operation of the application. The second level attribute indicates a factor (e.g., a supporting criteria, element, user behavior operation of the application) that affects and contributes to the goal. The third level attribute indicating a metric associated with the factor. The system accesses metrics that measure of operations of the application by a plurality of user accounts. A graphical user interface is generated for the first level attribute and displays the metric from the third level attribute. The third level attribute is mapped to the second level attribute for a set of user accounts from the plurality of user accounts based on the mapping definition. The system generates a configuration setting for the application of the set of user accounts based on the metric of the third level attribute. The system applies the configuration setting to the application for the set of user accounts.

As a result, one or more of the methodologies described herein facilitate solving the technical problem of optimizing user operations of an application. As such, one or more of the methodologies described herein may obviate a need for certain efforts or computing resources. Examples of such computing resources include processor cycles, network traffic, memory usage, data storage capacity, power consumption, network bandwidth, and cooling capacity.

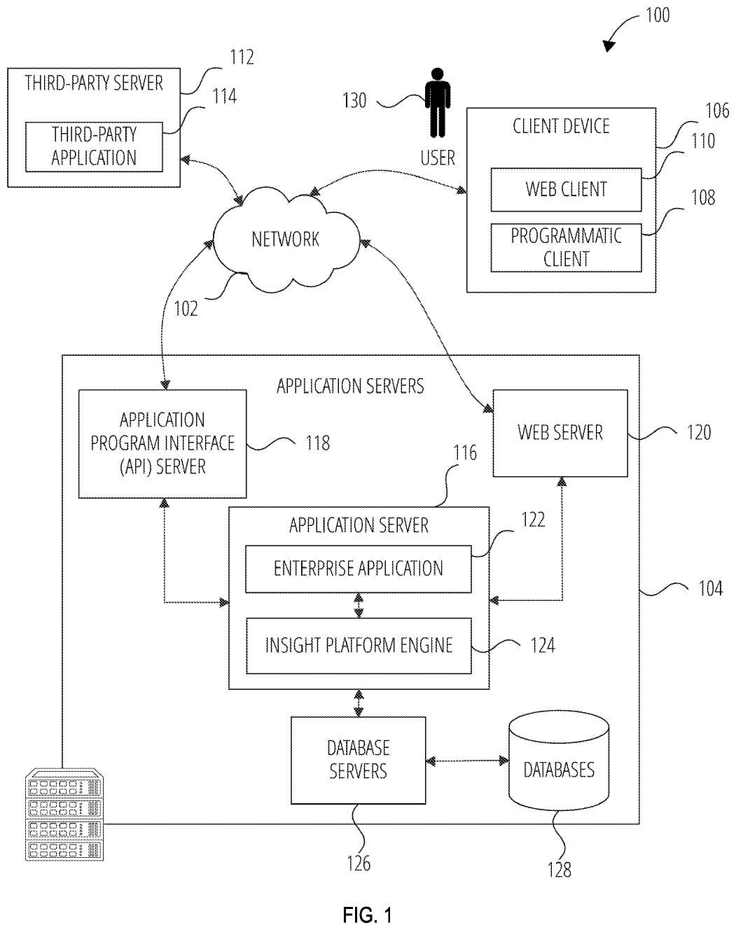

FIG. 1 is a diagrammatic representation of a network environment 100 in which some example embodiments of the present disclosure may be implemented or deployed. One or more application servers 104 provide server-side functionality via a network 102 to a networked user device, in the form of a client device 106. A user 130 operates the client device 106. The client device 106 includes a web client 110 (e.g., a browser), a programmatic client 108 (e.g., an email/calendar application such as Microsoft Outlook™, an instant message application, a document writing application, a shared document storage application) that is hosted and executed on the client device 106. In one example embodiment, the programmatic client 108 logs interaction data from the web client 110 and the programmatic client 108 with the enterprise application 122. In another example embodiment, the enterprise application 122 logs interaction data between the web client 110, the programmatic client 108, and the enterprise application 122. The interaction data may include, for example, communication logs of communications (e.g., emails) between users of an enterprise or communications between users of the enterprise and outside users of the enterprise. Other examples of interaction data include and are not limited to email communications, meeting communications, instant messages, shared document comments, and any communication with a recipient (e.g., a user from or outside the enterprise). In a first example, the interaction data include metadata of the messages. In a second example, the interaction data include content of the messages.

An Application Program Interface (API) server 118 and a web server 120 provide respective programmatic and web interfaces to application servers 104. A specific application server 116 hosts the enterprise application 122 and an insight platform engine 124. Both enterprise application 122 and insight platform engine 124 include components, modules and/or applications.

The enterprise application 122 includes a server side email/calendar enterprise application, a server side instant message enterprise application, a document authoring enterprise application, or a shared document storage enterprise application. The enterprise application 122 enables users of an enterprise to collaborate and share document, messages, and other data (e.g., meeting information, common projects) with each other. For example, the user 130 at the client device 106 accesses and uses the enterprise application 122 to edit documents that are shared with other users of the same enterprise. In another example, the client device 106 accesses and uses the enterprise application 122 to retrieve or send messages or emails to and from other peer users of the enterprise. Other examples of enterprise application 122 includes enterprise systems, content management systems, and knowledge management systems.

In one example embodiment, the insight platform engine 124 communicates with the enterprise application 122 and accesses user operation data of the enterprise application 122. The user operation data includes data points that measure the frequency, dates, times of users operating the enterprise application, types of documents being accessed or shared by users of the enterprise application, users calendar data from the enterprise application, communication data between users of the enterprise application, and enterprise organization data (e.g., hierarchy of users within an enterprise).

In another example embodiment, the insight platform engine 124 communicates with the programmatic client 108 and accesses operation data (or interaction data with other users of the enterprise) from the user 130 with the programmatic client 108 or web client 110. In one example, the web client 110 communicates with the insight platform engine 124 and enterprise application 122 via the programmatic interface provided by the Application Program Interface (API) server 118.

The insight platform engine 124 computes operation metrics (e.g., metrics that measure how the application is operated by users of the enterprise) based on operation data of the enterprise application 122 and interaction data between users of the enterprise. The operation data and interaction data is collected by a combination of the enterprise application 122, the item web client 110, or the programmatic client 108. The operation metrics may be associated with an enterprise or a group of user accounts within the enterprise. In one example, the insight platform engine 124 measures operation metrics based on operation data of the enterprise application 122 by a group of user accounts of the enterprise. In another example, the insight platform engine 124 measures interaction metrics based on interaction data of the group of user accounts using the enterprise application 122. In another example, the insight platform engine 124 measures operation metrics based on other filter criteria (group department, group size, group hierarchy—managers, supervisors, team leader, user physical location, office location).

The insight platform engine 124 computes enterprise benchmarks (also referred to as benchmark indices) based on operation and/or interaction metrics related to the enterprise application 122 for user accounts of other enterprises or user accounts of the same enterprise. The insight platform engine 124 generates a graphical user interface (GUI) indicates the operation/interaction metrics of a group of user accounts of the enterprise relative to the operation/interaction metrics of other groups of user accounts of the enterprise or user accounts of peer enterprises.

The insight platform engine 124 indicates a (user-interactive) portion of the GUI that identifies a set of user accounts. The insight platform engine 124 generates a configuration setting for the application of the set of user accounts based on the operation/interaction metrics of the set of user accounts relative to the other operation/interaction metrics of other user accounts of the enterprise or of other enterprises. The insight platform engine 124 applies the configuration setting to the enterprise application 122 for each user account of the set of user accounts. As such, the enterprise application 122 that is modified by configuration setting for a user account now operates in a different manner (e.g., generating more frequent or less different prompt reminders, modifying a setting of a communication application to automatically schedule one-on-one meetings with a manager, setting a limit to the number of attendees in a meeting).

Examples of configuration settings include changes to how the enterprise application 122 (for a corresponding user) operates at different times. For example, the enterprise application 122 may be configured to turn off any notification during a preset amount of time during the day. In another example, the enterprise application 122 may be configured to generate and display additional reminder notifications to further interact with identified co-workers. In another example, the enterprise application 122 may be configured to generate a dialog box pre-populated with information based on the recommended action (e.g., pre-filled with parameters of a feature of the enterprise application 122). The user 130 only has to click on one button to configure the programmatic client 108 with the new parameters. For example, the pre-filled parameters configure the programmatic client 108 to prevent from retrieving or sending emails between 10 pm and 6 am on weekdays and all day on weekends. Such configuration results in an increase or decrease in operation/interaction metrics of the enterprise application 122 associated with the user account.

The application server 116 is shown to be communicatively coupled to database servers 126 that facilitates access to an information storage repository or databases 128. In an example embodiment, the databases 128 includes storage devices that store information to be processed by the enterprise application 122 and the insight platform engine 124.

Additionally, a third-party application 114 may, for example, store another part of the enterprise application 122, or include a cloud storage system. For example, the third-party application 114 stores other metrics related to the enterprises. The metrics may include size of the enterprises, industry classification, and updated revenue. The third-party application 114 executing on a third-party server 112, is shown as having programmatic access to the application server 116 via the programmatic interface provided by the Application Program Interface (API) server 118. For example, the third-party application 114, using information retrieved from the application server 116, may supports one or more features or functions on a website hosted by the third party.

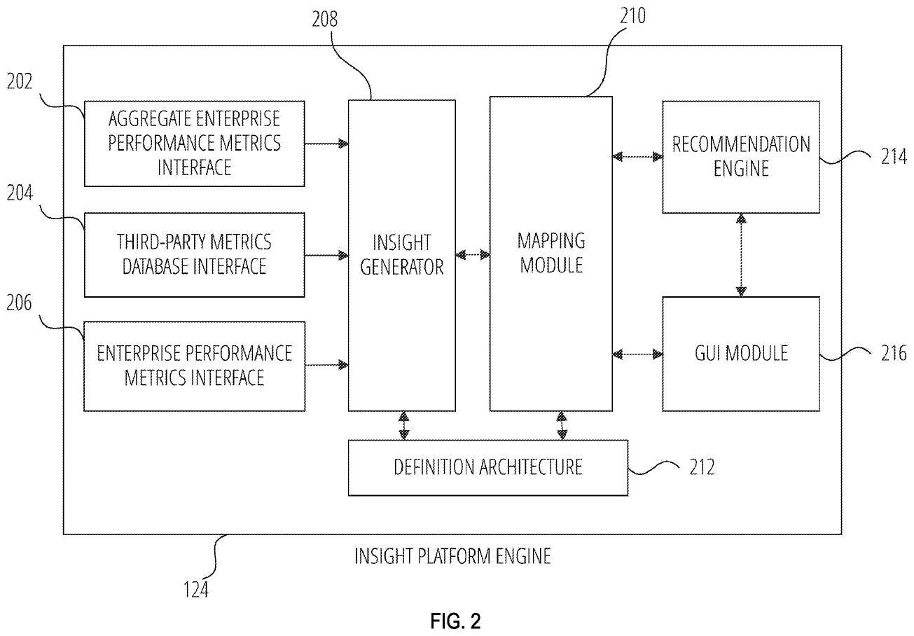

FIG. 2 is a block diagram illustrating an enterprise performance engine in accordance with one example embodiment. The insight platform engine 124 comprises an aggregate enterprise performance metrics interface 202, a third-party metrics database interface 204, an enterprise performance metrics interface 206, a recommendation engine 214, a definition architecture 212, a GUI module 216, an insight generator 208, and a mapping module 210.

The aggregate enterprise performance metrics interface 202 communicates with devices of all enterprises having access to the enterprise application 122. In one example embodiment, the aggregate enterprise performance metrics interface 202 accesses user operation/interaction data from devices of all enterprises having access to the enterprise application 122. The user operation data indicate user activities with the enterprise application 122 (e.g., when and how often the user is using the enterprise application 122). The user interaction data indicate interactions (e.g., types, frequency, dates, recipients identification) between user accounts of the enterprise using the enterprise application 122.

The third-party metrics database interface 204 communicates with a third party database (e.g., third-party server 112) that stores periodically updated profile data/operation metrics/interaction metrics of user accounts of other enterprises. In one example embodiment, the third-party metrics database interface 204 retrieves the periodically updated profile data/operation metrics/interaction metrics from the third-party server 112.

Examples of profile data obtained by the third-party metrics database interface 204 include revenue, industry classification, and size classification. By knowing the metrics, industry classification and size classification, the insight platform engine 124 can generate benchmarks by grouping the enterprises based on the combinations of industry classification and size classification.

The enterprise performance metrics interface 206 retrieves user operation/interaction data of the enterprise application 122 from user accounts associated with an enterprise. For example, the enterprise performance metrics interface 206 retrieves the user operation/interaction data from the enterprise application 122 or the client device 106 of the enterprise.

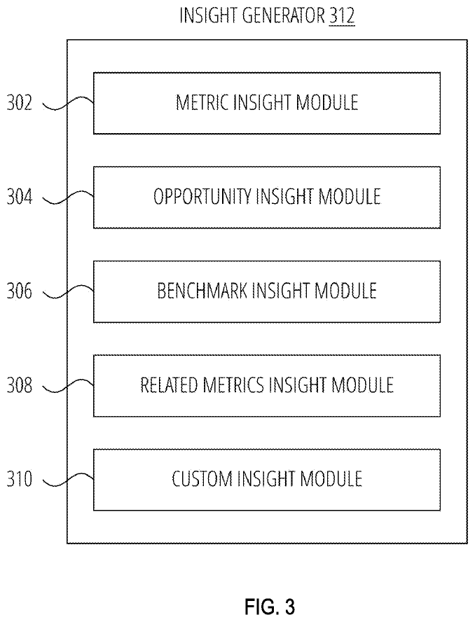

The insight generator 208 identifies metrics based on operation/interaction data of the enterprise application 122 from the user accounts associated with the enterprise. In one example embodiment, the insight generator 208 accesses the operation/interaction data from the aggregate enterprise performance metrics interface 202, the third-party metrics database interface 204, and the enterprise performance metrics interface 206 to identify operation metrics and interaction metrics. In another example, the insight generator 208 compares the operation/interaction metrics of user accounts (of the enterprise) operating the enterprise application 122 relative to the operation/interaction metrics of other user accounts (of the same enterprise or other enterprises) operating the enterprise application 122. Examples of insight attributes are described further below with respect to FIG. 3.

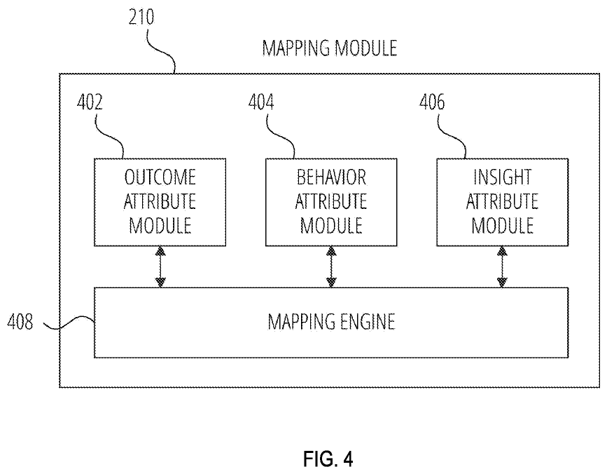

The mapping module 210 maps the operation/interaction metrics to one or more attributes (e.g., insight attributes). For example, the mapping module 210 maps the operation/interaction metrics to one or more third level attributes (e.g., insight attributes). Each third level attribute is mapped to one or more second level attribute (e.g., behavior attribute). Each second level attribute is mapped to one or more first level attribute (e.g., outcome attribute). An example of the mapping module 210 is described further below with respect to FIG. 4.

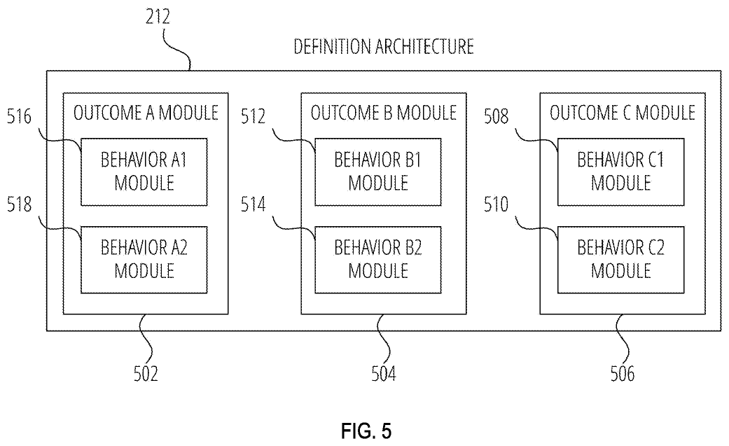

The definition architecture 212 defines metrics of the metrics discussed in FIG. 5 (e.g., metrics for third level attributes, third level attributes for the second level attributes, and second level attributes for the first level attributes). The mapping module 210 uses the definition of definition architecture 212 to map the operation/interaction metrics. An example of the definition architecture 212 is described further below with respect to FIG. 5.

The recommendation engine 214 generates a configuration setting (for the enterprise application 122) based on relative operation/interaction metrics of a set of user accounts relative to other user accounts (within the same enterprise or peer enterprises). For example, if the operation/interaction metrics of a set of user accounts is relatively less than the operation/interaction metrics of other user accounts of the enterprise (or below a benchmark index), the recommendation engine 214 provides one or more configuration setting (for the enterprise application 122) on how to increase the operation/interaction metrics. In one example embodiment, the recommendation engine 214 accesses a lookup table based on a user accounts index value of the operation/interaction metrics and identifies a recommended configuration setting based on an index margin threshold between the benchmark index and the user accounts index. The lookup table may specify different types of actions based on the value of the index margin threshold. For example, the different types of actions may vary based on the difference between benchmark index and the user accounts index (e.g., light configuration setting, moderate configuration setting, severe configuration setting).

In one example, the recommendation engine 214 generates a configuration setting that prevents users of the corresponding user accounts from emailing between midnight and 6 am. The recommendation engine 214 configures the enterprise application 122 with the configuration setting.

The GUI module 216 generates a GUI that indicates the operation/interaction metrics within the context of the first, second, and third level attributes. The GUI module 216 further identifies a set of user accounts that exhibits anomalous operation/interaction metrics relative to its peer user accounts of the same enterprise or different enterprises. The GUI module 216 defines a portion of the GUI to identify the set of the user accounts. The portion of the GUI may be interactive such that when a user selects the portion of the GUI, the GUI module 216 detects the selection and identifies the user accounts associated with the selection. The GUI module 216 provides the identification of the selected user accounts to the recommendation engine 214 to generate a configuration setting for the selected user accounts.

FIG. 3 illustrates an insight generator in accordance with one embodiment. The insight generator 312 comprises a metric insight module 302, a benchmark insight module 306, a related metrics insight module 308, a custom insight module 310, and an opportunity insight module 304. The insight generator 312 generates third level attributes. Example of third level attributes include metrics insight, opportunity insight, benchmark insight, related metrics insight, and custom insight.

The metric insight module 302 identifies metrics for the metrics insight attribute. For example, these insights generally outputs percentages of user accounts who satisfy the insight (e.g., percentage of user accounts with uninterrupted work hours less than 20 hours/week).

The opportunity insight module 304 identifies metrics for the opportunity insight attribute. For example, these insights compute the groups of user accounts in the organization who have a potential to improve (e.g., groups within the enterprise who have maximum percentage of people with uninterrupted hours less than 20 hours/week).

The benchmark insight module 306 identifies metrics for the benchmark insight attribute. For example, these insights provide a benchmark for the enterprise to compare the metric insight values with respect to the industry.

The related metrics insight module 308 identifies metrics for the related metrics insight attribute. For example, these insights provide an understanding of how some of the related metrics for the given behavior are performing (e.g., for uninterrupted hours, long or large meetings acts as a related metric since that can lead to less focus).

The custom insight module 310 identifies metrics for the custom insight attribute. For example, each of the above insights have different types of computations. Each insight can use data from different data sources. To allow for such varied computations and definitions, the custom insight module 310 enables to custom define metrics for a custom insight definition.

The insight generator 312 contains the logic to transform the insight definition (to a form which can be used to query the various data sources), to run the logic to obtain the insight, and then to transform the data obtained to the correct output format.

FIG. 4 illustrates a mapping module 210 in accordance with one embodiment. The mapping module 210 includes an outcome attribute module 402, a behavior attribute module 404, an insight attribute module 406, and a mapping engine 408.

The outcome attribute module 402 identifies an outcome (a goal or a desired state of utilizations or operations of the enterprise application 122) that includes a broad category of behaviors that help the enterprise improve productivity in an area. Examples of outcome attributes include user experience, organizational agility, and customer focus.

The behavior attribute module 404 identifies a behavior attribute that presents information on the behaviors of enterprise users for a specific metric. Examples of behavior attributes includes manager coaching (e.g., how regularly manager meets his directs), effective meetings (e.g., how efficient are the meetings conducted).

The insight attribute module 406 identifies an insight attribute that indicates information provided to the user accounts and helps analyze the behavior attribute. For example, a behavior attribute of effective meetings behavior would have a metric insight which indicates what percentage of users do not have effective meetings. The behavior attribute of effective meetings behavior also includes an opportunity insight that presents which organizations have the potential to improve. The behavior attribute of effective meetings behavior also includes an industrial benchmark insight that includes details on what is the general trends in the industry.

The mapping engine 408 maps the different attributes between outcome attribute module 402, behavior attribute module 404, and insight attribute module 406. The following illustrates an example of a mapping table between the outcome attribute module 402 and the insight attribute module 406, where Outcome 1 represents a first outcome attribute, I1 represents a first insight attribute, and I3 represents a second insight attribute:

| Outcome Identifier Attribute | Insight Identifier Attribute |
|---|---|
| Outcome1 | I1, I3 |
| Outcome2 | I2 |

The following illustrates an example of a mapping table between the insight attribute module 406 and corresponding interaction/operation metrics of the enterprise application I22, where I1 represents the first insight attribute, I2 represents a second insight attribute, I3 represents a third insight attribute, M1 represents a first metric from the operation/interaction metrics, M2 represents a second metric from the operation/interaction metrics, M3 represents a third metric from the operation/interaction metrics, M4 represents a fourth metric from the operation/interaction metrics, and M5 represents a fifth metric from the operation/interaction metrics.

| Insight Identifier | Metrics |
|---|---|
| I1 | M1, M3, M5 |
| I2 | M1, M2 |
| I3 | M4 |

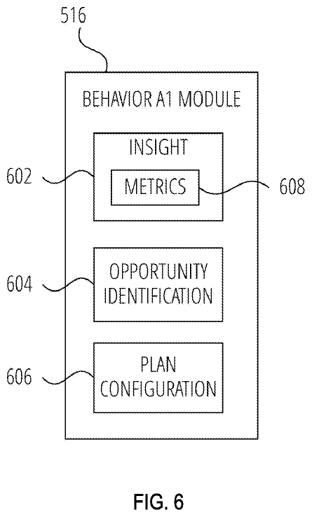

FIG. 5 illustrates a definition architecture 212 in accordance with one embodiment. The definition architecture 212 defines relationships between the outcome attributes, behavior attributes, and insight attributes. Each behavior attribute is associated with an outcome attribute ID. Each behavior attribute includes a set of insights attributes (further illustrated in FIG. 6) along with other metadata. In one example, the definition architecture 212 is stored in JSON format in database servers 126.

The definition architecture 212 includes outcome A module 502, outcome B module 504, outcome C module 506. Each outcome module includes its own set of behavior modules. For example, outcome A module 502 includes behavior A1 module 516, and behavior A2 module 518. The outcome B module 504, includes behavior B1 module 512, and behavior B2 module 514. The outcome C module 506 includes behavior C1 module 508, and behavior C2 module 510. An example of the behavior A1 module 516 is further described below with respect to FIG. 6.

FIG. 6 illustrates behavior A1 module 516 in accordance with one embodiment. The behavior A1 module 516 includes insight 602, opportunity identification 604, and plan configuration 606. Insight 602 includes corresponding metrics 608 of the operation/interaction metrics. The opportunity identification 604 identifies a set of user accounts with a relatively poor metrics index relative to a benchmark or a peer index. For example, a poor metrics index may be more than 20% off from the benchmark index. The plan configuration 606 identifies a set of configuration settings (from a look up table) to apply to the enterprise application 122 of the set of user accounts such that the metrics of the set of user accounts increases or decreases. In another example embodiment, the plan configuration 606 receives a selection of parameters for the configuration setting of the enterprise application 122. The plan configuration 606 provides the parameters and configuration settings to the recommendation engine 214.

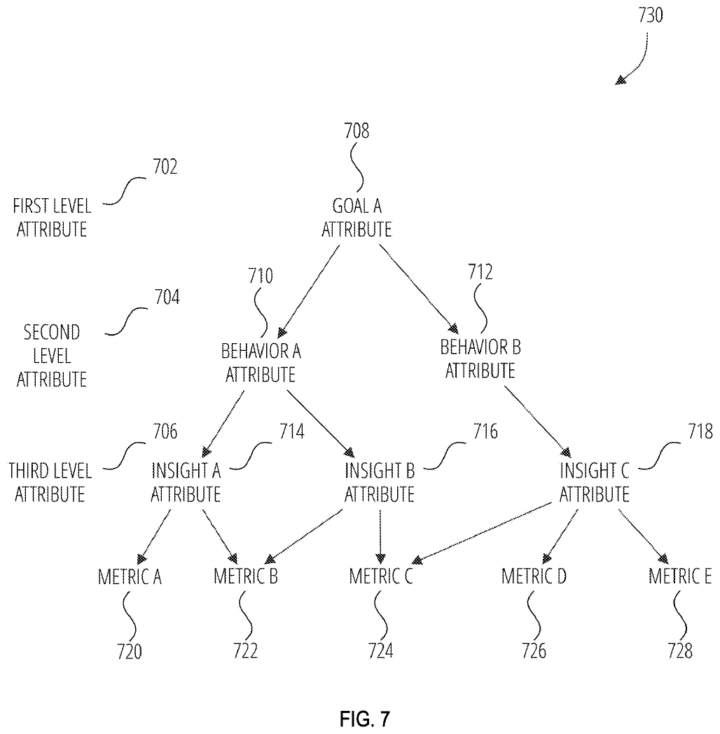

FIG. 7 is a diagram of a graph 730 illustrating an example of a mapping definition in accordance with one example embodiment. The graph 730 illustrates a first level attribute 702, a second level attribute 704, and a third level attribute 706. The first level attribute 702 may be, for example, a goal A attribute 708 (e.g., organizational agility). The first level attribute 702 is mapped to attributes from a second level attribute 704 (e.g., behavior A attribute 710, and behavior B attribute 712).

Each behavior attribute from the second level attribute 704 is mapped to a corresponding insight attribute from third level attribute 706. For example, behavior A attribute 710 is mapped to insight A attribute 714 and insight B attribute 716. The behavior B attribute 712 is mapped to insight C attribute 718.

Each insight attribute from the third level attribute 706 is mapped to a corresponding metric. For example, insight A attribute 714 is mapped to metric A 720 and metric B 722. The insight B attribute 716 is mapped to metric B 722 and metric C 724. The insight C attribute 718 is mapped to metric C 724, metric D 726, and metric E 728.

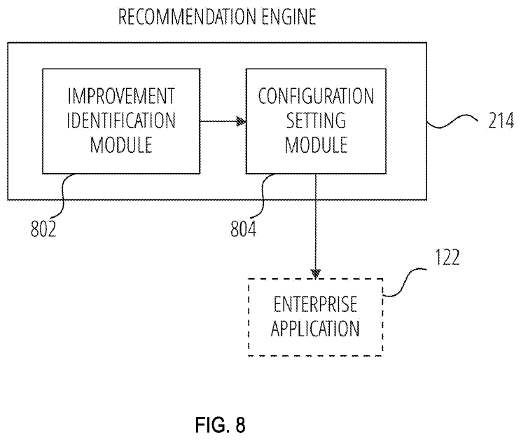

FIG. 8 illustrates recommendation engine 214 in accordance with one embodiment. recommendation engine 214 includes an improvement identification module 802 and a configuration setting module 804. The improvement identification module 802 identifies a set of users with the most potential for improvement. In one example, the improvement identification module 802 identifies a set of user accounts based on the metrics of the set of user accounts relative to the metrics of peer user accounts. In another example embodiment, the improvement identification module 802 identifies a set of user accounts based on a selection of user accounts in the GUI generated by the GUI module 216.

The configuration setting module 804 identifies a set of configuration settings to apply to the enterprise application 122 of the set of user accounts such that the metrics of the set of user accounts improve relative to the metrics of peer user accounts. In one example, the configuration setting module 804 generates operation parameters for the enterprise application 122: the enterprise application 122 may be operated by the set of user accounts between a preset period of time. In another example, the configuration setting module 804 generates notification parameters for the enterprise application 122: the enterprise application 122 generates additional reminders related to the metrics to the set of user accounts (e.g., nudge them to log on after hours, remind them to communicate with supervisor more frequently). The configuration setting module 804 provides the configuration setting to the enterprise application 122. The enterprise application 122 configures itself for the set of user accounts based on the configuration setting from configuration setting module 804.

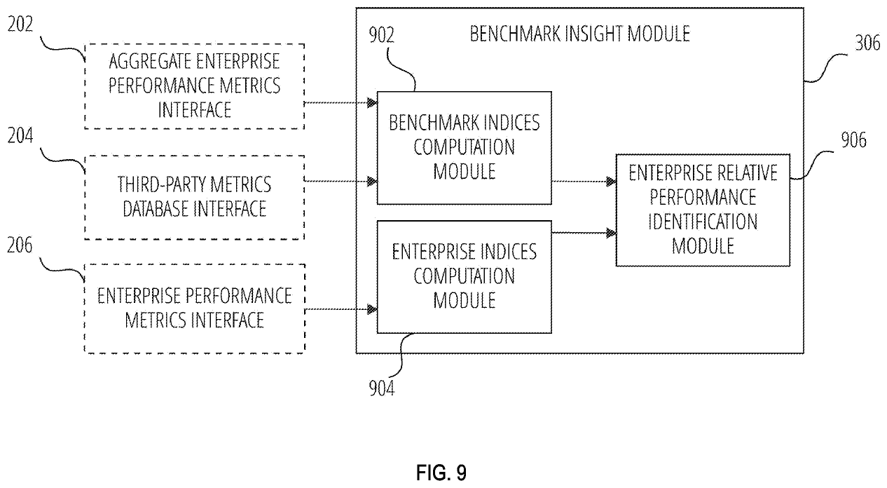

FIG. 9 is a block diagram illustrating benchmark insight module 306 in accordance with one example embodiment. The benchmark insight module 306 comprises a benchmark indices computation module 902, an enterprise indices computation module 904, and an enterprise relative performance identification module 906.

The aggregate enterprise performance metrics interface 202 communicates with devices of all enterprises having access to the enterprise application 122. In one example embodiment, the aggregate enterprise performance metrics interface 202 accesses user interaction data from devices of all enterprises having access to the enterprise application 122. The user interaction data includes any interaction between any user account of the enterprise with the enterprise application 122.

Examples of metrics obtained by the aggregate enterprise performance metrics interface 202 include: Multi-Tasking Hours, Meeting Hours, Work Week Span, After Hours Work (collaboration hours), % of employees who work greater than 50 hours per week and 5 hours after hours, Conflicting Hours, Large Meeting Hours, Long Meeting Hours, % of employees who work greater than 40 hours per week, Average Number of Geographies Per Person, % of employees that interact more than 1 hour externally, Ratio of external to internal collaboration, and Number of active mailboxes.

The third-party metrics database interface 204 communicates with a third party database (e.g., third-party server 112) that stores periodically updated profiles of the enterprises (e.g., enterprise size, revenue, industry, etc). In one example embodiment, the third-party metrics database interface 204 retrieves the periodically updated profiles data from the third-party server 112.

Examples of metrics obtained by the third-party metrics database interface 204 include revenue, industry classification, and size classification. By knowing the metrics, industry classification and size classification, the benchmark indices computation module 902 can generate benchmarks by grouping the companies based on the combinations of industry classification and size classification.

The enterprise performance metrics interface 206 retrieves user interaction data for the enterprise (e.g., a specific enterprise). For example, the enterprise performance metrics interface 206 retrieves the user interaction data from the enterprise application 122 or the client device 106 of the enterprise.

The benchmark indices computation module 902 retrieves aggregate interaction data from aggregate enterprise performance metrics interface 202 and enterprise profiles from the third-party metrics database interface 204. In one example embodiment, the benchmark indices computation module 902 computes benchmark indices based on the aggregate interaction data.

The enterprise indices computation module 904 computes performance indices (for a selected enterprise) based on the user interaction data from the enterprise. The enterprise relative performance identification module 906 generates a graph that indicates the performance indices of the enterprise relative to its peers as determined based on the profile of the enterprise.

In one example, the enterprise indices computation module 904 assigns the industry and size classification to the metrics of a specific enterprise. The enterprise indices computation module 904 measures workplace productivity by the spreads of the metrics in the same industry and size bucket combination. The benchmark indices computation module 902 determines the industry average for the scores. The enterprise relative performance identification module 906 measure the relative performance of the enterprise relative to peer enterprises.

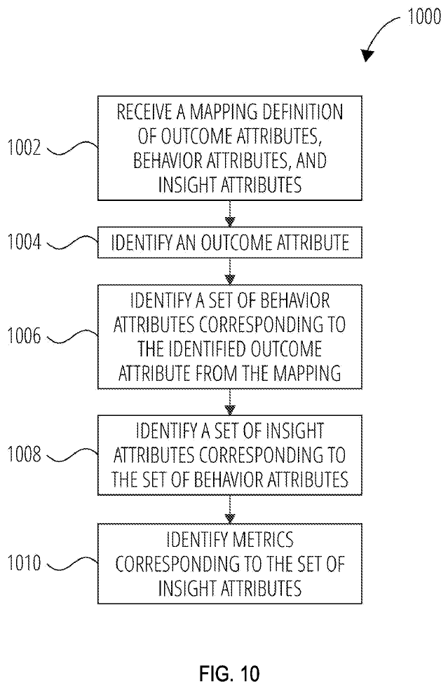

FIG. 10 is a flow diagram illustrating a method for computing a set of insight attributes in accordance with one example embodiment. Operations in the method 1000 may be performed by the insight platform engine 124, using components (e.g., modules, engines) described above with respect to FIG. 2. Accordingly, the method 1000 is described by way of example with reference to the insight platform engine 124. However, it shall be appreciated that at least some of the operations of the method 1000 may be deployed on various other hardware configurations or be performed by similar components residing elsewhere. For example, some of the operations may be performed at the client device 106.

At block 1002, the definition architecture 212 receives a mapping definition of outcome attributes, behavior attributes, and insight attributes. At block 1004, the mapping module 210 identifies an outcome attribute. At block 1006, the mapping module 210 identifies a set of behavior attributes corresponding to the identified outcome attribute from the mapping. At block 1008, the insight generator 208 identifies a set of insight attributes corresponding to the set of behavior attributes. At block 1010, the insight generator 208 identifies metrics corresponding to the set of insight attributes.

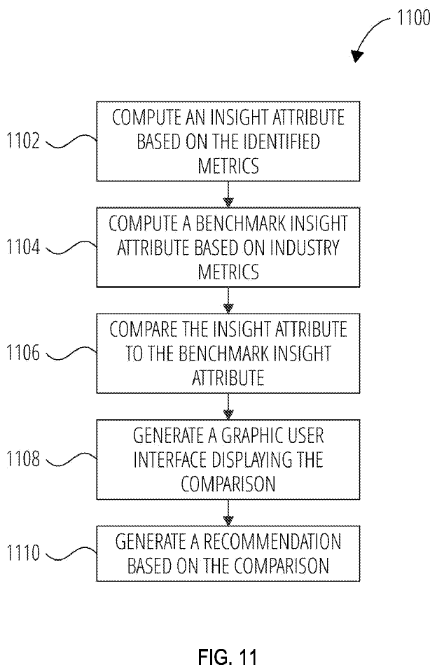

FIG. 11 is a flow diagram illustrating a method 1100 for generating a recommendation in accordance with one example embodiment. Operations in the method 1100 may be performed by the insight platform engine 124, using components (e.g., modules, engines) described above with respect to FIG. 2. Accordingly, the method 1200 is described by way of example with reference to the insight platform engine 124. However, it shall be appreciated that at least some of the operations of the method 1200 may be deployed on various other hardware configurations or be performed by similar components residing elsewhere. For example, some of the operations may be performed at the client device 106.

At block 1102, the insight generator 208 computes an insight attribute based on the identified metrics. At block 1104, the insight generator 208 computes a benchmark insight attribute based on industry metrics. At block 1106, the insight generator 208 compares the insight attribute to the benchmark insight attribute. At block 1108, the GUI module 216 generates a GUI displaying the comparison. At block 1110, the recommendation engine 214 generates a recommendation based on the comparison.

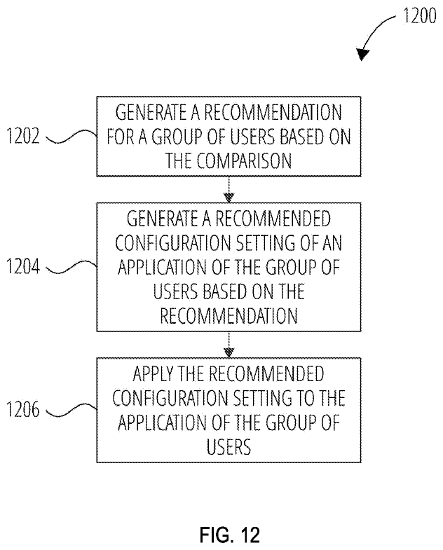

FIG. 12 is a flow diagram illustrating a method 1200 for applying the recommended configuration setting in accordance with one example embodiment. Operations in the method 1200 may be performed by the insight platform engine 124, using components (e.g., modules, engines) described above with respect to FIG. 2. Accordingly, the method 1200 is described by way of example with reference to the insight platform engine 124. However, it shall be appreciated that at least some of the operations of the method 1200 may be deployed on various other hardware configurations or be performed by similar components residing elsewhere. For example, some of the operations may be performed at the client device 106.

At block 1202, the recommendation engine 214 generates a recommendation for a group of users based on the comparison. At block 1204, the recommendation engine 214 generates a recommended configuration setting of the enterprise application 122 of the group of users based on the recommendation. At block 1206, the recommendation engine 214 applies the recommended configuration setting to the enterprise application 122 of the group of users.

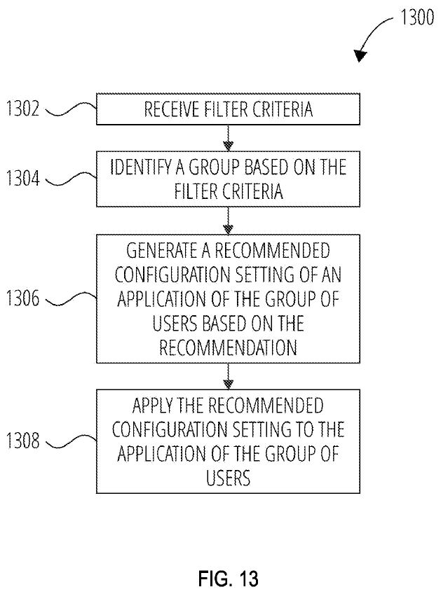

FIG. 13 is a flow diagram illustrating a method 1300 for applying the recommended configuration setting in accordance with one example embodiment. Operations in the method 1300 may be performed by the insight platform engine 124, using components (e.g., modules, engines) described above with respect to FIG. 2. Accordingly, the method 1300 is described by way of example with reference to the insight platform engine 124. However, it shall be appreciated that at least some of the operations of the method 1300 may be deployed on various other hardware configurations or be performed by similar components residing elsewhere. For example, some of the operations may be performed at the client device 106.

At block 1302, the definition architecture 212 receives a filter criteria. At block 1304, the mapping module 210 identifies a group of users based on the filter criteria. At block 1306, the recommendation engine 214 generates a recommended configuration setting of an application of the group of users based on the recommendation. At block 1308, the recommendation engine 214 applies the recommended configuration setting to the enterprise application 122 of the group of users.

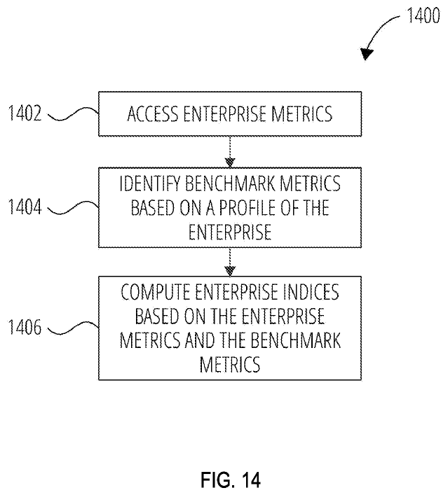

FIG. 14 is a flow diagram illustrating a method 1400 for computing enterprise indices in accordance with one example embodiment. Operations in the method 1400 may be performed by the insight platform engine 124, using components (e.g., modules, engines) described above with respect to FIG. 2. Accordingly, the method 1400 is described by way of example with reference to the insight platform engine 124. However, it shall be appreciated that at least some of the operations of the method 1400 may be deployed on various other hardware configurations or be performed by similar components residing elsewhere. For example, some of the operations may be performed at the client device 106.

At block 1402, the benchmark insight module 306 accesses enterprise metrics. At block 1404, the benchmark insight module 306 identifies benchmark metrics based on a profile of the enterprise. At block 1406, the benchmark insight module 306 computes enterprise indices based on the enterprise metrics and the benchmark metrics.

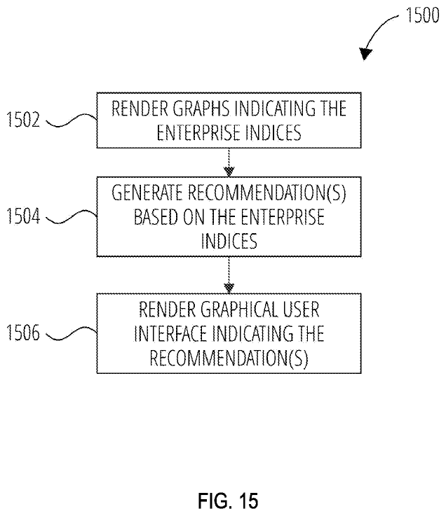

FIG. 15 is a flow diagram illustrating a method 1500 for rendering a graphical user interface in accordance with one example embodiment. Operations in the method 1500 may be performed by the insight platform engine 124, using components (e.g., modules, engines) described above with respect to FIG. 2. Accordingly, the method 1500 is described by way of example with reference to the insight platform engine 124. However, it shall be appreciated that at least some of the operations of the method 1500 may be deployed on various other hardware configurations or be performed by similar components residing elsewhere. For example, some of the operations may be performed at the client device 106.

At block 1502, the GUI module 216 renders a GUI indicating the enterprise indices. At block 1504, the recommendation engine 214 generates a recommendation based on the enterprise indices. At block 1506, the GUI module 216 renders a GUI indicating the recommendation.

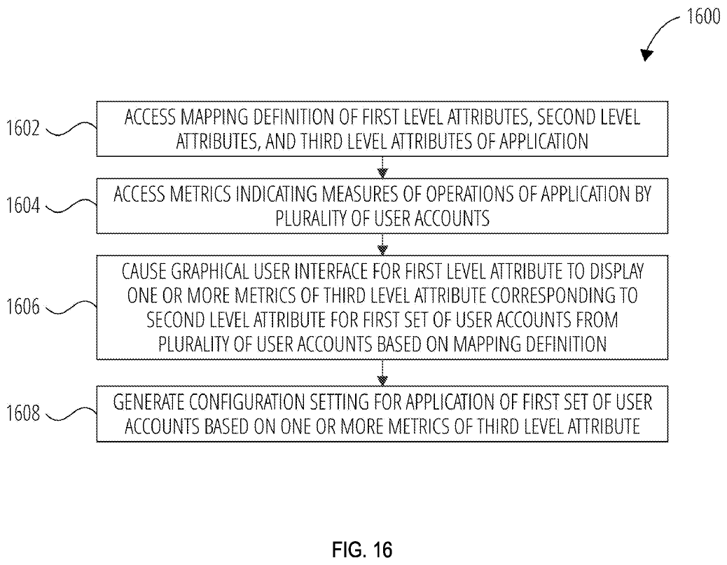

FIG. 16 illustrates a routine in accordance with one embodiment. In block 1602, routine 1600 accesses a mapping definition of first level attributes, second level attributes, and third level attributes of an application. In block 1604, routine 1600 accesses metrics indicating measures of operations of the application by a plurality of user accounts. In block 1606, routine 1600 causes a graphical user interface for a first level attribute to display one or more metrics of a third level attribute corresponding to a second level attribute for a first set of user accounts from the plurality of user accounts based on the mapping definition. In block 1608, routine 1600 generates a configuration setting for the application of the first set of user account based on the one or more metrics of the third level attribute.

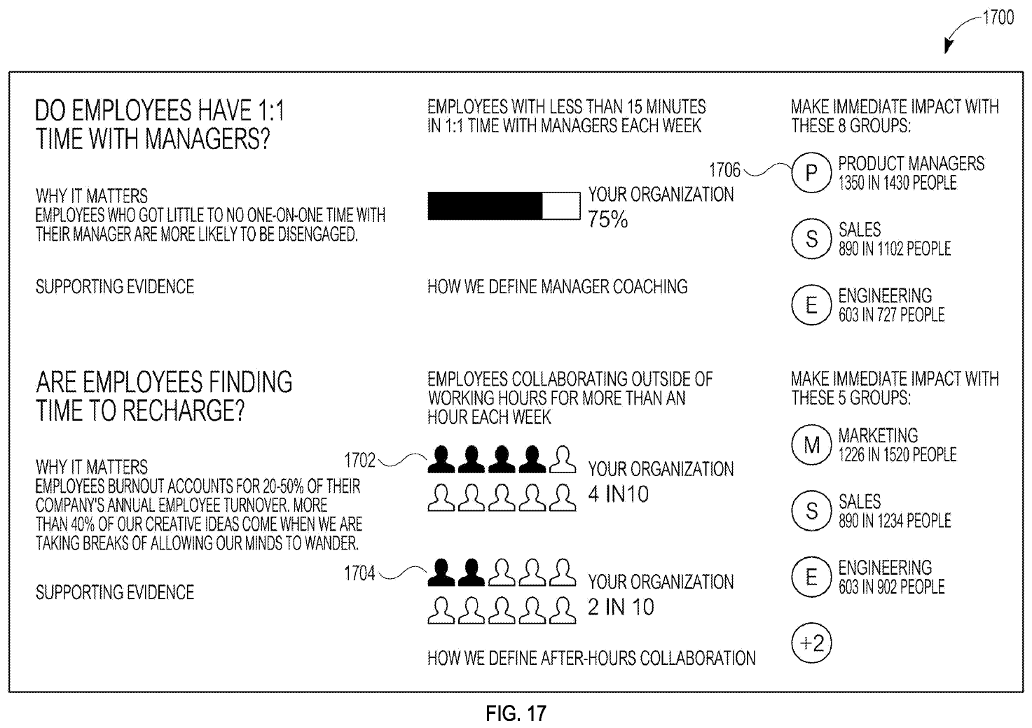

FIG. 17 illustrates an example of a graphical user interface 1700 in accordance with one example embodiment. The graphical user interface 1700 illustrates graphical user interface element 1702, graphical user interface element 1704, and user accounts 1706. The graphical user interface element 1702 illustrates metrics/indices related to a set of user accounts of the enterprise. The graphical user interface element 1704 illustrates metrics/indices related to users accounts of peer enterprises. The user accounts 1706 illustrates the different groups of user accounts.

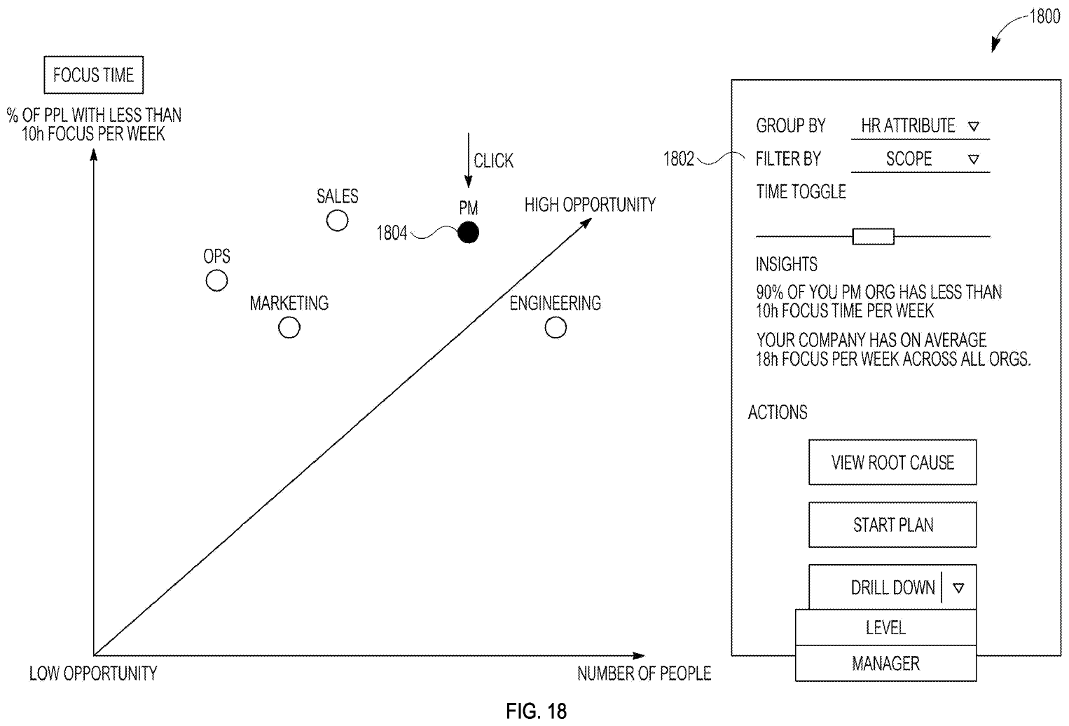

FIG. 18 illustrates an example of a graph 1800 in accordance with one example embodiment. The graph 1800 illustrates different user accounts based on a filter setting 1802 (interactive user interface). A user can select user accounts group 1804. The graph 1800 illustrates user accounts group based on uninterrupted work hours and number of people.

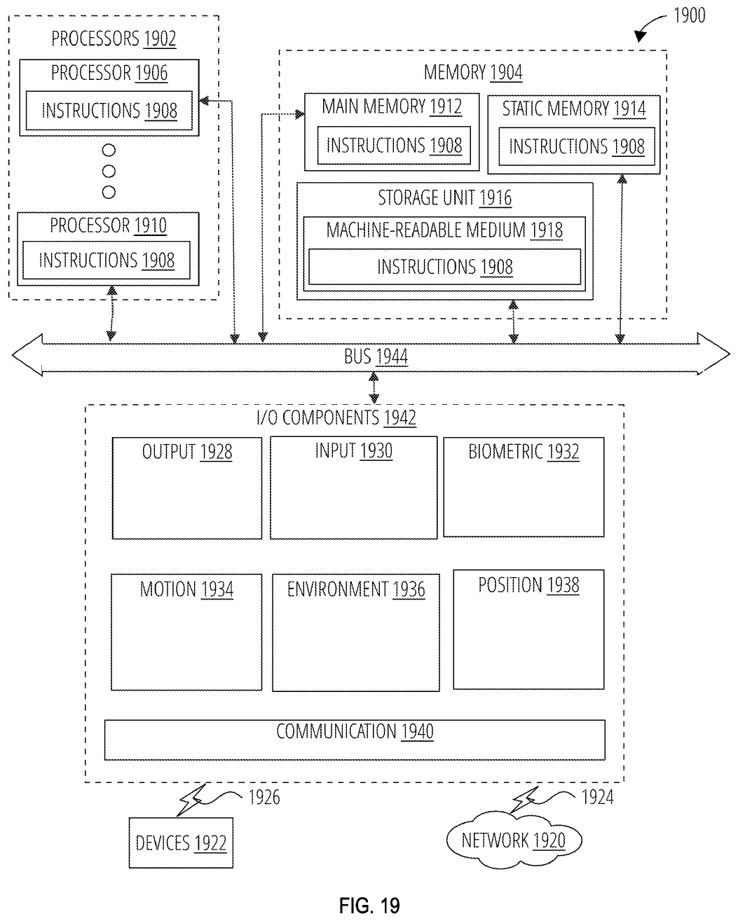

FIG. 19 is a diagrammatic representation of the machine 1900 within which instructions 1908 (e.g., software, a program, an application, an applet, an app, or other executable code) for causing the machine 1900 to perform any one or more of the methodologies discussed herein may be executed. For example, the instructions 1908 may cause the machine 1900 to execute any one or more of the methods described herein. The instructions 1908 transform the general, non-programmed machine 1900 into a particular machine 1900 programmed to carry out the described and illustrated functions in the manner described. The machine 1900 may operate as a standalone device or may be coupled (e.g., networked) to other machines. In a networked deployment, the machine 1900 may operate in the capacity of a server machine or a client machine in a server-client network environment, or as a peer machine in a peer-to-peer (or distributed) network environment. The machine 1900 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1908, sequentially or otherwise, that specify actions to be taken by the machine 1900. Further, while only a single machine 1900 is illustrated, the term “machine” shall also be taken to include a collection of machines that individually or jointly execute the instructions 1908 to perform any one or more of the methodologies discussed herein.

The machine 1900 may include processors 1902, memory 1904, and I/O components 1942, which may be configured to communicate with each other via a bus 1944. In an example embodiment, the processors 1902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1906 and a processor 1910 that execute the instructions 1908. The term “processor” is intended to include multi-core processors that may comprise two or more independent processors (sometimes referred to as “cores”) that may execute instructions contemporaneously. Although FIG. 19 shows multiple processors 1902, the machine 1900 may include a single processor with a single core, a single processor with multiple cores (e.g., a multi-core processor), multiple processors with a single core, multiple processors with multiples cores, or any combination thereof.

The memory 1904 includes a main memory 1912, a static memory 1914, and a storage unit 1916, both accessible to the processors 1902 via the bus 1944. The main memory 1904, the static memory 1914, and storage unit 1916 store the instructions 1908 embodying any one or more of the methodologies or functions described herein. The instructions 1908 may also reside, completely or partially, within the main memory 1912, within the static memory 1914, within machine-readable medium 1918 within the storage unit 1916, within at least one of the processors 1902 (e.g., within the processor's cache memory), or any suitable combination thereof, during execution thereof by the machine 1900.

The I/O components 1942 may include a wide variety of components to receive input, provide output, produce output, transmit information, exchange information, capture measurements, and so on. The specific I/O components 1942 that are included in a particular machine will depend on the type of machine. For example, portable machines such as mobile phones may include a touch input device or other such input mechanisms, while a headless server machine will likely not include such a touch input device. It will be appreciated that the I/O components 1942 may include many other components that are not shown in FIG. 19. In various example embodiments, the I/O components 1942 may include output components 1928 and input components 1930. The output components 1928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1942 may include biometric components 1932, motion components 1934, environmental components 1936, or position components 1938, among a wide array of other components. For example, the biometric components 1932 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1934 include acceleration sensor components (e.g., accelerometer), gravitation sensor components, rotation sensor components (e.g., gyroscope), and so forth. The environmental components 1936 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1938 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1942 further include communication components 1940 operable to couple the machine 1900 to a network 1920 or devices 1922 via a coupling 1924 and a coupling 1926, respectively. For example, the communication components 1940 may include a network interface component or another suitable device to interface with the network 1920. In further examples, the communication components 1940 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1922 may be another machine or any of a wide variety of peripheral devices (e.g., a peripheral device coupled via a USB).

Moreover, the communication components 1940 may detect identifiers or include components operable to detect identifiers. For example, the communication components 1940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1940, such as location via Internet Protocol (IP) geolocation, location via Wi-Fi® signal triangulation, location via detecting an NFC beacon signal that may indicate a particular location, and so forth.

The various memories (e.g., memory 1904, main memory 1912, static memory 1914, and/or memory of the processors 1902) and/or storage unit 1916 may store one or more sets of instructions and data structures (e.g., software) embodying or used by any one or more of the methodologies or functions described herein. These instructions (e.g., the instructions 1908), when executed by processors 1902, cause various operations to implement the disclosed embodiments.

The instructions 1908 may be transmitted or received over the network 1920, using a transmission medium, via a network interface device (e.g., a network interface component included in the communication components 1940) and using any one of a number of well-known transfer protocols (e.g., hypertext transfer protocol (HTTP)). Similarly, the instructions 1908 may be transmitted or received using a transmission medium via the coupling 1926 (e.g., a peer-to-peer coupling) to the devices 1922.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### EXAMPLES

Example 1 is a computer-implemented method comprising: accessing a mapping definition that defines a mapping between a first level attribute, a second level attribute, and a third level attribute of an application, the first level attribute indicating a goal of an operation of the application, the second level attribute indicating a factor that contributes to the goal, the third level attribute indicating a metric associated with the factor; accessing metrics that measure of operations of the application by a plurality of user accounts; generating a graphical user interface for the first level attribute, the graphical user interface configured to display the metric from the third level attribute that is mapped to the second level attribute for a set of user accounts from the plurality of user accounts based on the mapping definition; and generating a configuration setting for the application of the set of user accounts based on the metric of the third level attribute.

Example 2 is the computer-implemented method of example 1, further comprising: identifying a set of user metrics from the metrics for the set of user accounts, the set of user metrics corresponding to the third level attribute, the third level attribute being mapped to the second level attribute; and presenting the set of user metrics for the set of user accounts in the graphical user interface.

Example 3 is the computer-implemented method of any of the above examples, further comprising: identifying a value of the first level attribute; identifying the second level attribute corresponding to the value of the first level attribute based on the mapping definition; identifying the third level attribute corresponding to the second level attribute based on the mapping definition; and identifying a metric corresponding to the third level attribute.

Example 4 is the computer-implemented method of any of the above examples, wherein the first level attribute comprises an outcome attribute, the second level attribute comprises a behavior attribute, and the third level attribute comprises an insight attribute, wherein the mapping definition maps the outcome attribute to one or more behavior attributes, the behavior attribute being mapped to one or more insight attributes, each insight attribute being mapped to one or more metrics.

Example 5 is the computer-implemented method of any of the above examples, further comprising: computing a benchmark metric corresponding to the set of user accounts, the benchmark metric measuring an operation of the application by other user accounts of the application, the operation being based on collaboration activities by the other user accounts of the application; comparing the metric from the third level attribute for the set of user accounts to the benchmark metric; and presenting the comparison in the graphical user interface.

Example 6 is the computer-implemented method of any of the above examples, further comprising: defining a portion of the graphical user interface as an opportunity region; identifying a target group of user accounts corresponding to the opportunity region; receiving a filter value corresponding to the target group of user accounts; filtering the target group of user account based on the filter value; generating the configuration setting based on the filter value; and applying the configuration setting to the application of the filtered target group of user accounts.

Example 7 is the computer-implemented method of any of the above examples, further comprising: generating the configuration setting for the set of user accounts based on the comparison; and configuring the application with the configuration setting for the set of user accounts.

Example 8 is the computer-implemented method of any of the above examples, wherein the metrics indicates at least one of periods of operations of the application by the plurality of user accounts, frequencies of operations of the application by the plurality of user accounts, periods of communications transmitted using the application by the plurality of user accounts, frequencies of communications transmitted using the application by the plurality of user accounts, subject matter of communications transmitted using the application by the plurality of user accounts, recipients of communications transmitted using the application by the plurality of user accounts.

Example 9 is the computer-implemented method of any of the above examples, further comprising: accessing interaction data that measure interactions between the plurality of user accounts of the application; identifying features of the interaction data; associating one or more features with one or more first level attributes; receiving a selection of the first level attribute; identifying the features corresponding to the selected first level attribute; and generating a feature graphical user interface based on the identified features.

Example 10 is the computer-implemented method of any of the above examples, wherein the application comprises a communication application or a calendar application.

What is claimed is:

1. A computer-implemented method comprising:
accessing a mapping definition that defines a mapping between a first level attribute, a second level attribute, and a third level attribute of an application, the first level attribute indicating a goal of an operation of the application, the second level attribute indicating a factor that contributes to the goal, the third level attribute indicating a metric associated with the factor;
accessing metrics that measure of operations of the application by a plurality of user accounts;
generating a graphical user interface for the first level attribute, the graphical user interface configured to display the metric from the third level attribute that is mapped to the second level attribute for a set of user accounts from the plurality of user accounts based on the mapping definition; and
generating a configuration setting for the application of the set of user accounts based on the metric of the third level attribute.

2. The computer-implemented method of claim 1, further comprising:
identifying a set of user metrics from the metrics for the set of user accounts, the set of user metrics corresponding to the third level attribute, the third level attribute being mapped to the second level attribute; and
presenting the set of user metrics for the set of user accounts in the graphical user interface.

3. The computer-implemented method of claim 1, further comprising:
identifying a value of the first level attribute;
identifying the second level attribute corresponding to the value of the first level attribute based on the mapping definition;
identifying the third level attribute corresponding to the second level attribute based on the mapping definition; and
identifying a metric corresponding to the third level attribute.

4. The computer-implemented method of claim 1, wherein the first level attribute comprises an outcome attribute, the second level attribute comprises a behavior attribute, and the third level attribute comprises an insight attribute,
wherein the mapping definition maps the outcome attribute to one or more behavior attributes, the behavior attribute being mapped to one or more insight attributes, each insight attribute being mapped to one or more metrics.

5. The computer-implemented method of claim 1, further comprising:
computing a benchmark metric corresponding to the set of user accounts, the benchmark metric measuring an operation of the application by other user accounts of the application, the operation being based on collaboration activities by the other user accounts of the application;
comparing the metric from the third level attribute for the set of user accounts to the benchmark metric; and
presenting the comparison in the graphical user interface.

6. The computer-implemented method of claim 5, further comprising:
defining a portion of the graphical user interface as an opportunity region;
identifying a target group of user accounts corresponding to the opportunity region;
receiving a filter value corresponding to the target group of user accounts;
filtering the target group of user account based on the filter value;
generating the configuration setting based on the filter value; and
applying the configuration setting to the application of the filtered target group of user accounts.

7. The computer-implemented method of claim 5, further comprising:
generating the configuration setting for the set of user accounts based on the comparison; and
configuring the application with the configuration setting for the set of user accounts.

8. The computer-implemented method of claim 1, wherein the metrics indicates at least one of periods of operations of the application by the plurality of user accounts, frequencies of operations of the application by the plurality of user accounts, periods of communications transmitted using the application by the plurality of user accounts, frequencies of communications transmitted using the application by the plurality of user accounts, subject matter of communications transmitted using the application by the plurality of user accounts, or recipients of communications transmitted using the application by the plurality of user accounts.

9. The computer-implemented method of claim 1, further comprising:
accessing interaction data that measure interactions between the plurality of user accounts of the application;
identifying features of the interaction data;
associating one or more features with one or more first level attributes;
receiving a selection of the first level attribute;
identifying the features corresponding to the selected first level attribute; and
generating a feature graphical user interface based on the identified features.

10. The computer-implemented method of claim 1, wherein the application comprises a communication application or a calendar application.

11. A computing apparatus, the computing apparatus comprising:
a processor; and
a memory storing instructions that, when executed by the processor, configure the apparatus to:
access a mapping definition that defines a mapping between a first level attribute, a second level attribute, and a third level attribute of an application, the first level attribute indicating a goal of an operation of the application, the second level attribute indicating a factor that contributes to the goal, the third level attribute indicating a metric associated with the factor;
access metrics that measure of operations of the application by a plurality of user accounts;
generate a graphical user interface for the first level attribute, the graphical user interface configured to display the metric from the third level attribute that is mapped to the second level attribute for a set of user accounts from the plurality of user accounts based on the mapping definition; and
generate a configuration setting for the application of the set of user accounts based on the metric of the third level attribute.

12. The computing apparatus of claim 11, wherein the instructions further configure the apparatus to:
identify a set of user metrics from the metrics for the set of user accounts, the set of user metrics corresponding to the third level attribute, the third level attribute being mapped to the second level attribute; and
present the set of user metrics for the set of user accounts in the graphical user interface.

13. The computing apparatus of claim 11, wherein the instructions further configure the apparatus to:
identify a value of the first level attribute;
identify the second level attribute corresponding to the value of the first level attribute based on the mapping definition;
identify the third level attribute corresponding to the second level attribute based on the mapping definition; and
identify a metric corresponding to the third level attribute.

14. The computing apparatus of claim 11, wherein the first level attribute comprises an outcome attribute, the second level attribute comprises a behavior attribute, and the third level attribute comprises an insight attribute,
wherein the mapping definition maps the outcome attribute to one or more behavior attributes, the behavior attribute being mapped to one or more insight attributes, each insight attribute being mapped to one or more metrics.

15. The computing apparatus of claim 11, wherein the instructions further configure the apparatus to:
compute a benchmark metric corresponding to the set of user accounts, the benchmark metric measuring an operation of the application by other user accounts of the application, the operation being based on collaboration activities by the other user accounts of the application;
compare the metric from the third level attribute for the set of user accounts to the benchmark metric; and
present the comparison in the graphical user interface.

16. The computing apparatus of claim 15, wherein the instructions further configure the apparatus to:
define a portion of the graphical user interface as an opportunity region;
identify a target group of user accounts corresponding to the opportunity region;
receive a filter value corresponding to the target group of user accounts;
filter the target group of user account based on the filter value;
generate the configuration setting based on the filter value; and
apply the configuration setting to the application of the filtered target group of user accounts.

17. The computing apparatus of claim 15, wherein the instructions further configure the apparatus to:
generate the configuration setting for the set of user accounts based on the comparison; and
configure the application with the configuration setting for the set of user accounts.

18. The computing apparatus of claim 11, wherein the metrics indicates at least one of periods of operations of the application by the plurality of user accounts, frequencies of operations of the application by the plurality of user accounts, periods of communications transmitted use the application by the plurality of user accounts, frequencies of communications transmitted using the application by the plurality of user accounts, subject matter of communications transmitted using the application by the plurality of user accounts, or recipients of communications transmitted using the application by the plurality of user accounts.

19. The computing apparatus of claim 11, wherein the instructions further configure the apparatus to:
access interaction data that measure interactions between the plurality of user accounts of the application;
identify features of the interaction data;
associate one or more features with one or more first level attributes;
receive a selection of the first level attribute;
identify the features corresponding to the selected first level attribute; and
generate a feature graphical user interface based on the identified features.

20. A non-transitory computer-readable storage medium, the computer-readable storage medium including instructions that when executed by a computer, cause the computer to:
access a mapping definition that defines a mapping between a first level attribute, a second level attribute, and a third level attribute of an application, the first level attribute indicating a goal of an operation of the application, the second level attribute indicating a factor that contributes to the goal, the third level attribute indicating a metric associated with the factor;
access metrics that measure of operations of the application by a plurality of user accounts;
generate a graphical user interface for the first level attribute, the graphical user interface configured to display the metric from the third level attribute that is mapped to the second level attribute for a set of user accounts from the plurality of user accounts based on the mapping definition; and
generate a configuration setting for the application of the set of user accounts based on the metric of the third level attribute.
